(19) United States
(12) Patent Application Publication
(10) Pub. No.: US 2022/0404637 A1
(43) Pub. Date: Dec. 22, 2022

(54) SPECTACLES WITH REPLACEABLE PINS

(71) Applicant: Wenzhou Eyestar Eyewear Co., Ltd., Wenzhou (CN)

(72) Inventor: Lixiao WANG, Wenzhou (CN)

(21) Appl. No.: 17/367,439

(22) Filed: Jul. 5, 2021

(30) Foreign Application Priority Data
Jun. 18, 2021 (CN) 202110679814.2

(51) Int. Cl. G02C 5/14

(52) U.S. Cl. CPC G02C 5/146; G02C 2200/32; G02C 2200/26

(57) ABSTRACT

Disclosed are spectacles with replaceable pins, and belongs to the technical field of spectacles. The spectacles with the replaceable pins may include a spectacle frame and the pins, an edge of the spectacle frame being pivoted with a bolt, the bolt being inserted into an inserting hole of the pin, an elastic piece pushing a stopping block to enter into an opening on a side of the pin, and the spectacle frame being connected with the pins in a buckling manner. When a pressure is applied to the stopping block, the stopping block withdraws from the opening on the side of the pin when elastic force of the elastic piece is overcome and retracts into the accommodation cavity, in this way the buckling connection of the spectacle frame with the pins is removed, the pins and the spectacle frame are demountable, and it is convenient to replace the pins.

### TECHNICAL FIELD

The disclosure relates to the technical field of spectacles, and in particular to spectacles with replaceable pins.

### BACKGROUND

In spectacles, a connecting piece (also known as a hinge) configured to connect a spectacle frame and pins is an important component of the spectacles. A hinge screw is generally taken as the connecting piece of the spectacles, and may effectively connect the pins with the spectacle frame. However, a screwdriver or other tools need to be taken as an auxiliary tool to assemble and disassemble, and it is hard to operate. When needing to replace the spectacle frame or the pins, a user usually needs to go to a special spectacle store for replacement, and it is very inconvenient for the user. With the improvement of the living standard of people, people's pursuit of beauty becomes stronger and stronger, a single color or style of the spectacles may not meet the needs of people's lives, and different spectacles need to be often replaced. Therefore, it is urgent for the people to design spectacles with the demountable pins and the spectacle frame and convenience to replace the pins.

### SUMMARY

In view of this, it is necessary to provide spectacles with detachable pins and spectacle frame and convenience to replace the pins in allusion to the abovementioned problem.

To achieve the abovementioned objective, the disclosure takes the following technical solution.

Spectacles with replaceable pins may include:

a spectacle frame, and

two pins.

Two opposite edges of the spectacle frame are pivoted with a bolt, respectively.

An inserting hole fitting the bolt is formed on one end of the pin in a concave manner.

A side of the pin is provided with an opening communicating with the inserting hole.

The bolt is provided with an accommodation cavity therein, and a stopping block is accommodated inside the accommodation cavity. An elastic piece is arranged inside the accommodation cavity as well, and the elastic piece is configured to push the stopping block to enter into the opening on the side of the pin.

When connection of the spectacle frame with the pins is realized, the bolt on the edge of the spectacle frame is inserted into the inserting hole of the pin, the elastic piece pushes the stopping block to enter into the opening on the side of the pin, and the spectacle frame is connected with the pin in a buckling manner.

When the connection of the spectacle frame with the pins is removed, a pressure is applied to the stopping block, and the stopping block withdraws from the opening on the side of the pin when elastic force of the elastic piece is overcome and retracts into the accommodation cavity, in this way the buckling connection of the spectacle frame with the pins is removed.

Preferably, the accommodation cavity is a square blind hole, the stopping block is a square block fitting the accommodation cavity, and an inner wall of the accommodation cavity guides the stopping block when the stopping block is pushed in the accommodation cavity.

Preferably, the elastic piece is a compression spring, one end of the compression spring is placed in abutment with a bottom of the accommodation cavity, and another end of the compression spring is placed in abutment with a bottom of the stopping block.

Preferably, a counter bore is arranged inside a top end surface of the stopping block, a screw goes through the counter bore and the compression spring in sequence until it is screwed into a screw hole arranged on the bottom of the accommodation cavity.

Preferably, there is one elastic piece, a round blind hole is arranged in the middle of a bottom end surface of the stopping block. One end of the elastic piece is placed in abutment with the bottom of the accommodation cavity, and another end of the elastic piece is placed in abutment with a bottom of the round blind hole.

Preferably, there are two elastic pieces, and the two elastic pieces are arranged on two ends of the stopping block, respectively.

Preferably, the bolt is provided with a round angle facilitating insertion of the bolt into the inserting hole.

Preferably, the edge of the spectacle frame is provided with a first limitation gap, and an end of the bolt is provided with a first limitation block fitting the first limitation gap.

Preferably, the edge of the spectacle frame is provided with a second limitation gap, and the end of the pin is provided with a second limitation block fitting the second limitation gap.

The beneficial effects of the disclosure are as follows.

The edge of the spectacle frame is pivoted with the bolt, the bolt is inserted into the inserting hole of the pin, the elastic piece pushes the stopping block to enter into the opening on the side of the pin, and the spectacle frame is connected with the pins in the buckling manner. The pressure is applied to the stopping block, and the stopping block withdraws from the opening on the side of the pin when the elastic force of the elastic piece is overcome and retracts into the accommodation cavity, in this way the buckling connection of the spectacle frame with the pins is removed, the pins and the spectacle frame are demountable, and it is convenient to replace the pins.

### BRIEF DESCRIPTION OF THE DRAWINGS

FIG. 1 is a structure diagram of a spectacle frame, a bolt and a stopping block in an embodiment 1.

FIG. 2 is a structure diagram of a spectacle frame and pins in an embodiment 1.

FIG. 3 is a schematic diagram of buckling connection of pins and a spectacle frame in an embodiment 1.

FIG. 4 is a location diagram of placing an elastic piece in an embodiment 2.

### REFERENCE NUMBERS

1. Spectacle frame; 2. Pin; 3. Bolt; 4. Inserting hole; 5. Opening; 6. Accommodation cavity; 7. Stopping block, 8. Elastic piece; 9. Counter bore; 10. Round angle; 11. First limitation block; 12. Second limitation gap; 13. Second limitation block, 14. Screw; 15. Round blind hole.

### DETAILED DECEPTION OF THE EMBODIMENTS

In order to describe the embodiments of the disclosure or the technical solutions in the conventional art more clearly, the disclosure will be further introduced below in combination with the detailed embodiments and drawings. It is apparent that the drawings described below are not all embodiments but part of embodiments of the disclosure. Other drawings may be obtained by those of ordinary skill in the art on the basis of the drawings without creative work.

It is to be understood that orientation or position relationships indicated by terms “upper”, “lower”, “front”, “back”, “left”, “right”, “transverse”, “top”, “inside” and the like are orientation or position relationships shown in the drawings usually, are adopted not to indicate or imply that indicated devices or components must be in specific orientations or structured and operated in specific orientations but only to conveniently describe the disclosure and simplify descriptions and thus should not be understood as limits to the disclosure.

Terms “first”, “second” and “third” are used for describing the objective, and shall not be understood to indicate or imply relative importance or impliedly indicate quantity of the indicated technical features. Therefore, the features defined with “first”, “second” and “third” may indicate or impliedly include one or more features. Unless otherwise described, “one group” in the description of the disclosure means two or more than two.

### Embodiment

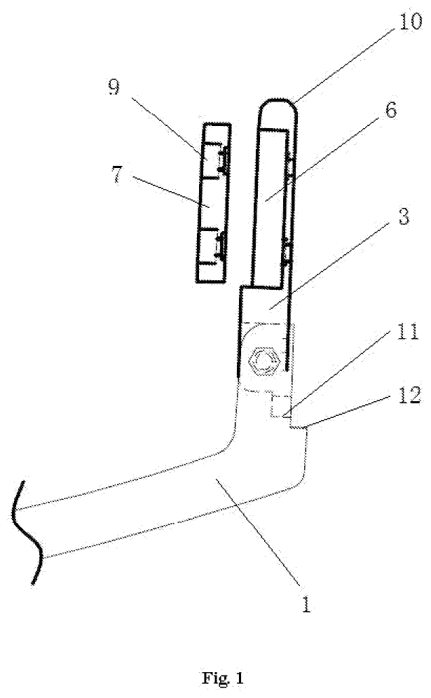

As shown in FIG. 1-FIG. 3, spectacles with replaceable pins may include:

a spectacle frame 1, and

two pins 2.

Two opposite edges of the spectacle frame 1 are pivoted with a bolt 3, respectively.

An inserting hole 4 fitting the bolt 3 is formed on one end of the pin 2 in a concave manner.

A side of the pin 2 is provided with an opening 5 communicating with the inserting hole 4.

The bolt 3 is provided with an accommodation cavity 6 therein, and a stopping block 7 is accommodated inside the accommodation cavity 6. An elastic piece 8 is arranged inside the accommodation cavity 6 as well, and the elastic piece 8 may push the stopping block 7 to enter into the opening 5 on the side of the pin 2.

When connection of the spectacle frame 1 with the pins 2 is realized, the bolt 3 on the edge of the spectacle frame 1 is inserted into the inserting hole 4 of the pin 2, the elastic piece 8 pushes the stopping block 7 to enter into the opening 5 on the side of the pin 2, and the spectacle frame 1 is connected with the pin 2 in a buckling manner. When the connection of the spectacle frame 1 with the pins 2 needs to be removed, a pressure is applied to the stopping block 7, and the stopping block 7 withdraws from the opening 5 on the side of the pin 2 when elastic force of the elastic piece 8 is overcome and retracts into the accommodation cavity 6, in this way the buckling connection of the spectacle frame 1 with the pins 2 is removed.

In the embodiment, the accommodation cavity 6 is a square blind hole, the stopping block 7 is a square block fitting the accommodation cavity 6, an inner wall of the accommodation cavity 6 guides the stopping block 7 when the stopping block 7 is pushed by the elastic piece 8 in the accommodation cavity 6, and the stopping block 7 may be accurately inserted into the opening 5 on the side of the pin 2.

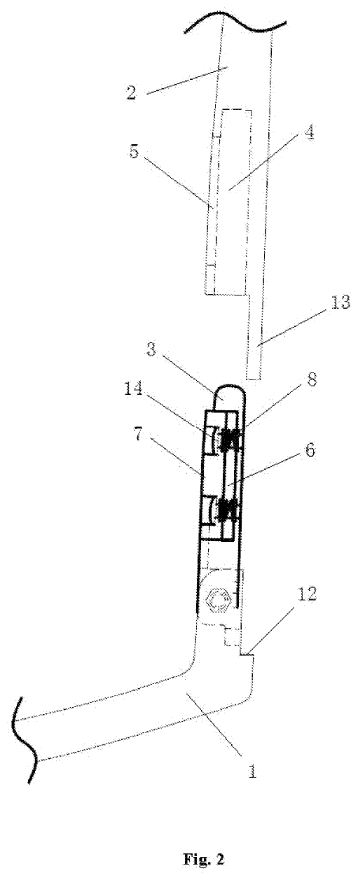

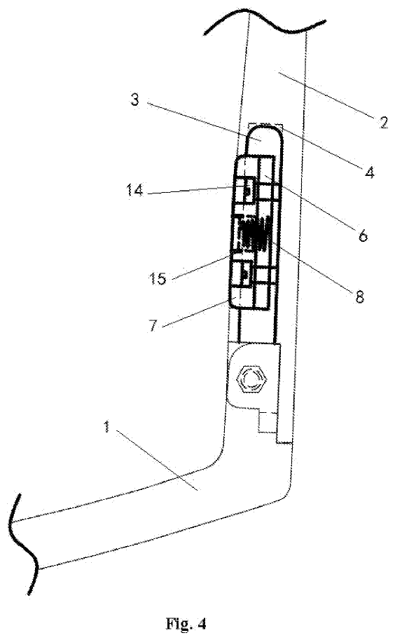

As shown in FIG. 1 and FIG. 2, in the embodiment, the elastic piece 8 is a compression spring, one end of the compression spring is placed in abutment with a bottom of the accommodation cavity 6, and another end of the compression spring is placed in abutment with a bottom of the stopping block 7. More specifically, in the embodiment, a counter bore 9 (as shown in FIG. 1) is arranged on a top end surface of the stopping block 7, a screw 14 goes through the counter bore 9 and the compression spring in sequence until it is screwed into a screw hole arranged on the bottom of the accommodation cavity 6, and the screw 14 locks the stopping block 7 and prevents it from departing from the accommodation cavity 6. Specifically, in the embodiment, there are two elastic pieces 8, and the two elastic pieces 8 are arranged on two ends of the stopping block 7, respectively. In other embodiments, there is one elastic piece 8, a round blind hole 15 (as shown in FIG. 4) is arranged in the middle of a bottom end surface of the stopping block 7. One end of the elastic piece 8 is placed in abutment with the bottom of the accommodation cavity 6, and another end of the elastic piece 8 is placed in abutment with a bottom of the round blind hole 15.

As shown in FIG. 1, in the embodiment, the bolt 3 is provided with a round angle 10 facilitating insertion of the bolt 3 into the inserting hole 4 of the pin 2, in this way convenience of assembling and disassembling the pins 2 and the spectacle frame 1 is further improved.

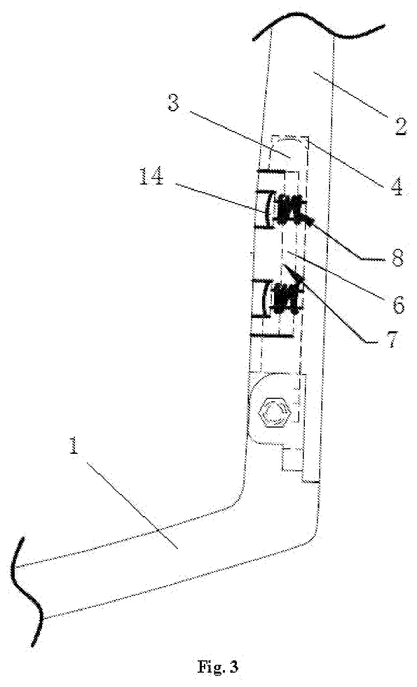

As shown in FIG. 1-FIG. 2, in the embodiment, the edge of the spectacle frame 1 is provided with a first limitation gap, and an end of the bolt 3 is provided with a first limitation block 11 fitting the first limitation gap. The first limitation block 11 of the bolt 3 may be placed in abutment with the first limitation gap on the edge of the spectacle frame 1 when the bolt 3 is opened, in this way a maximum opening angle of the bolt 3 is 90°. As shown in FIG. 2-FIG. 3, in the embodiment, the edge of the spectacle frame 1 is further provided with a second limitation gap 12, and the end of the pin 2 is provided with a second limitation block 13 fitting the second limitation gap 12. The second limitation block 13 of the pin 2 may be placed in abutment with the second limitation gap 12 on the edge of the spectacle frame 1 when the pin 2 is opened, in this way a maximum opening angle of the pin 2 is 90°.

The abovementioned embodiment presents several embodiments of the disclosure only, and its description is relatively specific and detailed, but the specific and detailed description shall not be understood as limits to the scope of patent of the disclosure. It is to be pointed out that those of ordinary skill in the art can make various variations and improvements without departing from the concept of the present disclosure as well, and these variations and improvements shall also fall within the scope of protection of the disclosure. Therefore, the attached claims shall prevail in terms of the scope of protection of the disclosure.

What is claimed is:

1. Spectacles with replaceable pins, comprising:
a spectacle frame; and
two pins;
two opposite edges of the spectacle frame being pivoted with a bolt, respectively;
an inserting hole fitting the bolt being formed on one end of the pin in a concave manner;
a side of the pin being provided with an opening communicating with the inserting hole;
the bolt being provided with an accommodation cavity therein, and a stopping block being accommodated inside the accommodation cavity; an elastic piece being arranged inside the accommodation cavity as well, and the elastic piece being configured to push the stopping block to enter into the opening on the side of the pin;
when connection of the spectacle frame with the pins is realized, the bolt on the edge of the spectacle frame being inserted into the inserting hole of the pin, the elastic piece pushing the stopping block to enter into the opening on the side of the pin, and the spectacle frame being connected with the pin in a buckling manner, and
when the connection of the spectacle frame with the pins is removed, a pressure being applied to the stopping block, and the stopping block withdrawing from the opening on the side of the pin when elastic force of the elastic piece is overcome and retracting into the accommodation cavity, in this way the buckling connection of the spectacle frame with the pins being removed.

2. The spectacles with replaceable pins as claimed in claim 1, wherein, the accommodation cavity is a square blind hole, the stopping block is a square block fitting the accommodation cavity, and an inner wall of the accommodation cavity guides the stopping block when the stopping block is pushed in the accommodation cavity.

3. The spectacles with replaceable pins as claimed in claim 1, wherein, the elastic piece is a compression spring, one end of the compression spring is placed in abutment with a bottom of the accommodation cavity, and another end of the compression spring is placed in abutment with a bottom of the stopping block.

4. The spectacles with replaceable pins as claimed in claim 3, wherein, a counter bore is arranged inside a top end surface of the stopping block, and a screw goes through the counter bore and the compression spring in sequence until it is screwed into a screw hole arranged on the bottom of the accommodation cavity.

5. The spectacles with replaceable pins as claimed in claim 1, wherein, there are two elastic pieces, and the two elastic pieces are arranged on two ends of the stopping block, respectively.

6. The spectacles with replaceable pins as claimed in claim 1, wherein, there is one elastic piece, a round blind hole is arranged in the middle of a bottom end surface of the stopping block, one end of the elastic piece is placed in abutment with the bottom of the accommodation cavity, and another end of the elastic piece is placed in abutment with a bottom of the round blind hole.

7. The spectacles with replaceable pins as claimed in claim 1, wherein, the bolt is provided with a round angle facilitating insertion of the bolt into the inserting hole.

8. The spectacles with replaceable pins as claimed in claim 1, wherein, the edge of the spectacle frame is provided with a first limitation gap, and an end of the bolt is provided with a first limitation block fitting the first limitation gap.

9. The spectacles with replaceable pins as claimed in claim 1, wherein, the edge of the spectacle frame is further provided with a second limitation gap, and the end of the pin is provided with a second limitation block fitting the second limitation gap.
